(19) United States
(12) Patent Application Publication
(10) Pub. No.: US 2002/0156777 A1
(43) Pub. Date: Oct. 24, 2002

(54) System and processes for configuring and accessing software applications and data for mobile use

(76) Inventor: Jagannadh Raju, Fremont, CA (US)

Correspondence Address: JAGANNADH RAJU, 34618 PUEBLO TERRACE, FREMONT, CA, 94555, US

(21) Appl. No.: 09/681,499

(22) Filed: Apr. 18, 2001

(51) Int. Cl. G06F 7/00

(52) U.S. Cl. 707/4

(57) ABSTRACT

The system and processes allow companies to enable their software applications and data to be accessed by users via mobile devices. The system provides an application configurator and an application interface engine, so that companies can tailor their software applications and data for mobile transactions and queries, without having to reprogram the software applications or reconfigure the data sources.

### BACKGROUND OF INVENTION

Most software applications currently used by businesses are developed in technologies that are best suited for use on the personal computer, and not for mobile devices. Mobile devices such as phones and personal digital assistants use different application level protocols and often require different types of interfaces to access a company's data sources. For example, a customer may have an ‘Orders’ application running on their network and accessed by the company users, using a personal computer, for performing different types of transactions and queries such as: ‘entering orders’, ‘scheduling orders’, ‘querying order status’, ‘querying inventory’, etc. However, a company may choose to provide only a subset of these transactions and queries, or choose to limit the amount of content exposed to the user for a given transaction or query, due to the constraints of the mobile devices. Such requirements often need developing new programs, or altering existing programs, or reconfiguring the data sources. The present invention alleviates this issue by providing companies a system and process that will dynamically access the company's existing software applications and data sources, via mobile devices, without having to alter the software application or reconfigure the data sources.

### BRIEF DESCRIPTION OF THE DRAWINGS

FIG. 1 shows a general overview of the different elements of a mobile network for data access.

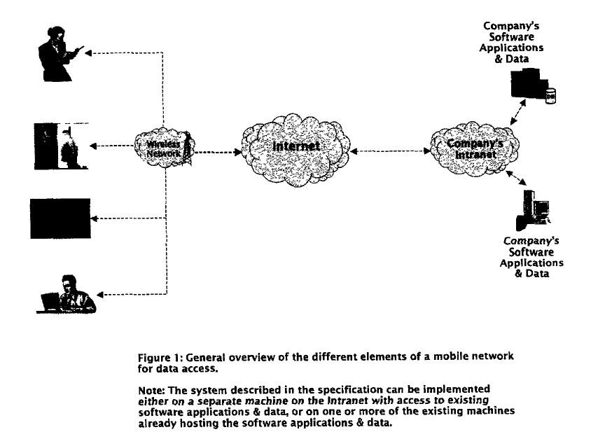

FIG. 2 shows the processes used by the present invention, and also the components of the system implementing the processes.

FIG. 3 shows a sample Transaction definition screen.

FIG. 4 shows a sample Query definition screen.

### DETAILED DESCRIPTION

The present invention describes a system and process for allowing companies to enable their software applications and data to be accessed by users via mobile devices such as phones and personal digital assistants. The primary focus of the invention is to dynamically access the company's software applications and data sources without having to reprogram the software applications or reconfigure the data sources.

The system comprises of two primary components:

1. Application Configurator (also referred to as “Configurator”)

2. Dynamic Application Interface Engine (also referred to as “Engine”)

Application Configurator

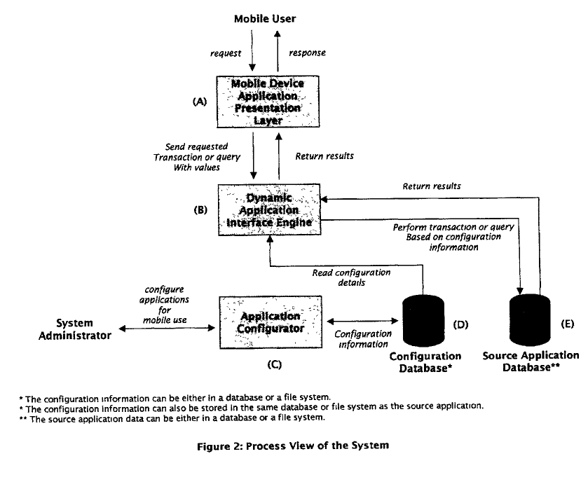

The Application Configurator (FIG. 2, Item C) is a component of the system that will allow a user to specify, using simple web based forms, the parts of a software application or data source that should be enabled for mobile use.

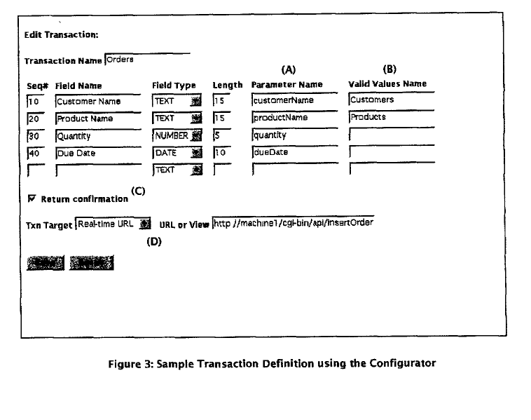

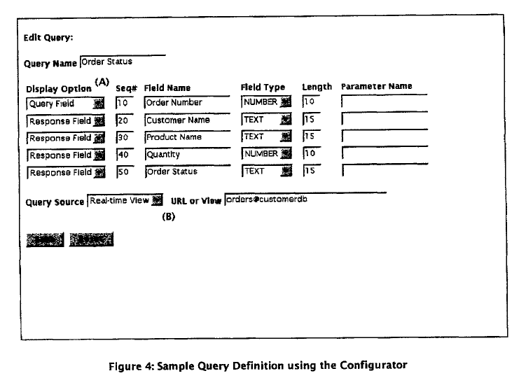

The two most commonly performed operations on a software application or data source are: transactions and queries. The Configurator user can specify several properties for each transaction and query. Such properties include the name or similar identification of the transaction or query, the names or identification of each of it's fields, and the characteristics of the fields such as sequence, type and length (FIG. 3, FIG. 4).

In the case of Queries, and additional property called “Display Option” can be used (FIG. 4, Item A). This property will inform the System as to which fields should be used as parameters to query the source database (FIG. 2, Item E) and which fields should be queried from the source database to be sent back to the mobile device. For example, a query named ‘Order Status’ can have field named ‘Order Number’ that is entered by the user to query the order's status (specified with Display Option: Query Field), and can have fields named ‘Customer Name’, ‘Product Name’, and ‘Order Status’ that are queried from the data source, for the given order number, and sent back to the user for review (specified with Display Option: Response Field).

For each field defined in the Configurator, a data source of valid values for each field, can be specified (FIG. 3, Item B). This information is used by the Engine to validate the field data received from the mobile device, prior to performing the transaction or query.

For each transaction and query, a data source where the data should be inserted to in the case of transactions, and where the data should be queried from in the case of queries, can be specified. The data source can be a database table, a database view, a software API (Application Program Interface), or a file system (FIG. 2, Item E). The data source specification can also include a reference to an ODBC (Open Database Connectivity) source. For example, for an “Enter Orders” transaction, the data source value be specified as “orders@customerdb” (FIG. 4, Item B) where “orders” represents the table name and “customerdb”represents the database name.

For transactions, users often request the return of a confirmation number. This can be specified using the Configurator (FIG. 3, Item C). The Engine will use the data source of the transaction to get the confirmation number and return it to the user.

The Configurator also allows the company to set up user authentication. Users of the system can be defined using the Configurator and stored in a local database, or the Configurator can be used to point to an existing LDAP (Lightweight Directory Access Protocol) repository on the company's network.

Dynamic Application Interface Engine

Once a user requests to perform a transaction or query via a mobile device, the request is received on the server by the Dynamic Application Interface Engine (FIG. 2, Item B). The Engine will evaluate the request based on the configuration properties specified in the Configurator and dynamically connects to the source system (FIG. 2, Item E).

If the data source is specified as a database table or a database view, it will construct a SQL (Structured Query Language) statement and inserts the data into the corresponding columns of the database table, in case of a transaction, and selects the data from the corresponding columns of the database table, in case of a query.

If the data source is specified as a software API, the Engine will construct the appropriate program call statements to access the software API, and sends the data as parameters to the software API. For example if the software API is specified to be called via http—hypertext transfer protocol (FIG. 3, Item D), the Engine will dynamically generate the needed statements to execute this call.

If the data source is specified as a local data store, the Engine will insert the data into a local database table. A generic table structure is used to store data from any and all types of transactions defined in the Configurator.

In the case of transactions, if field is marked to be validated by specifying the ‘valid values name’ (FIG. 3, Item B), the Engine will validate the received data for the field against the specified valid values data source, prior to performing the transaction.

For transactions, if a return confirmation is requested (FIG. 3, Item C), the Engine will use the transaction's data source to determine the method to get the confirmation number. If the data source is a database table or database view, the Engine will use the database's automatic unique identification generation features. If the data source is a software API, the confirmation number is generated and returned to the Engine by the software API, upon completion of the transaction.

It will be appreciated from the foregoing that the present invention represents a significant advance in the field of enabling software applications and data for mobile use. In particular, the invention provides both a system and technique for automating the process of configuring software applications and data for mobile use without having to reprogram the software applications or restructure the data sources, thereby permitting software applications and data sources to be enabled for mobile use more rapidly than by using conventional manual techniques. It will also be appreciated that, although a specific embodiment of the invention has been illustrated and described, various modifications may be made without departing from the spirit and scope of the invention.

1. The use of an application configurator system (configurator) and processes to map a software application, or parts of a software application, or a specific data source, to adapt for use on mobile devices.

2. The types of information that can be specified using the Configurator defined in claim 1 include:
Identification for the transaction or query
Identification of the fields for the transaction or query
Characteristics of the field such as sequence, type and length.
In the case of queries, a display option for the field, to indicate whether the field is used as a query parameter or as response data.
A parameter for each field, to be used when interfacing with the data source via a software API (Application Program Interface).
Source of valid values for each field. These valid values can be can be accessed from an existing database table, database view, or a file system.
Source of data for the transaction or query. The source can be a database table, a database view, a software API, or a file system. The source specification can also include a reference to an ODBC (Open Database Connectivity) source.
In case of transactions, enabling the return of a confirmation number for the transaction.
An LDAP (Lightweight Directory Access Protocol) source for user authentication.

3. The use of a Dynamic Application Interface Engine system (Engine) to perform the transaction or queries using the information specified in the Application Configurator system defined in claim 1.

4. The types of actions performed by the Engine defined in claim 3 include:
For transactions and queries, the Engine will dynamically parse the data source information specified in the Configurator defined in claim 1. If the data source is a database table or database view, the Engine will create the needed SQL (Structured Query Language) statements to interact with the source database. In the case of a transaction, an “insert” or “update” SQL statement is prepared and executed. In the case of a query, a “select” SQL statement is prepared and executed. If the data source is a software API, the Engine will create the applicable statements to call the program (e.g. a HTTP call is generated in case of a software API that supports HTTP Hypertext Transfer Protocol). The program call will supply the data to the software API via parameters that are specified in the Configurator defined in claim 1.
For transactions, if the data source is specified as local, the Engine will prepare the needed SQL statements and inserts the data into a local database table. A generic table structure is used to store data from any and all types of transactions defined in the Configurator defined in claim 1.
For transactions, the Engine will return a confirmation number for the transaction if such a request is specified in the Configurator defined in claim 1. If the data source is a database table or database view, the Engine will use the database's automatic unique identification generation features. If the data source is a software API, the confirmation number is generated and returned to the Engine by the software API, upon completion of the transaction.

5. While the primary objective of the features of the Configurator and Engine described in claim 2 and claim 4 respectively are to enable existing software applications for mobile use, they are however, not limited only to existing software applications; The same features can be used and are capable to define new software applications for mobile use.
